(19) United States
(12) Patent Application Publication
(10) Pub. No.: US 2015/0368943 A1
(43) Pub. Date: Dec. 24, 2015

(54) TRACK MOUNTED OVERHEAD DOOR STOP

(71) Applicant: Richard A. Mishler, Gnadenhutten, OH (US)

(72) Inventor: Richard A. Mishler, Gnadenhutten, OH (US)

(21) Appl. No.: 14/310,553

(22) Filed: Jun. 20, 2014

(51) Int. Cl. E05C 17/02; E06B 3/46

(52) U.S. Cl. CPC E05C 17/02; E06B 3/4636

(57) ABSTRACT

An overhead door track stop that affords variable placement to be utilized for all models of overhead door systems, even when settling occurs. The overhead door track stop allows for variable placement for securing within an overhead door guide track channel to provide a universal means to prevent the opening of different overhead door systems. The present invention can be laterally and vertically shifted to provide ideal placement adjacent with the overhead door track roller to prevent movement. The overhead door track stop disclosed herein is easily removed without the use of extraneous items or tools and can easily be mounted within an overhead door guide track channel with minimal effort.

### FIELD OF THE INVENTION

The invention herein resides generally in the art devices for preventing the opening of an overhead door, which devices will be generally referred to as overhead door stops. In some embodiments, the present invention relates to an overhead door stop including an elongate rigid body having slot-shaped apertures that allow for variable placement along an overhead door guide track channel to provide a universal means to prevent the opening of different overhead door systems.

### BACKGROUND OF THE INVENTION

Known overhead door locking systems can be directly installed onto different overhead door models or are mounted directly on the overhead door itself. However, these known systems are difficult to move, require tools for installment and provide little support to the structure when the overhead door system becomes worn. Further, overhead door systems are made in a variety of sizes and guide track widths and the location of apertures in the guide track is variable from door to door such that not all locks can be readily employed. The devices taught by the prior art have the potential for not being able to adapt to these different types of models or sizes, making them either impossible to mount or able to mount but allowing movement of the door upwardly to some extent, thus defeating the purpose of the stop.

Some systems employ a sliding lock mounted directly on the overhead door of which a locking portion is passed through a rectangular aperture in an overhead door guide track for locking with a padlock. However, these locking systems become ineffective or non-operative when the overhead door shifts over time due to settling of the foundation.

These common problems are often seen with foreclosed properties owned by lenders, often referred to as “real estate owned” or “REO” properties. Break-ins are common among such properties due to their vulnerable conditions, therefore the focal point of entrance becomes most often through or under the overhead door.

U.S. Pat. Nos. 6,463,989 and 8,333,091 disclose overhead door locking systems to prevent movement of an overhead door. However, these systems are disadvantageous for a number of reasons. These systems would not operate properly once settling of the foundation has occurred. In order to be effective, the blocking mechanisms need to be directly situated above an overhead door roller. Once a foundation has settled the placement of the apertures, which are necessary for the blocking device to be directly adjacent to the overhead door roller, become skewed. Therefore, if the ideal aperture is not accessible, a different disadvantageous placement of the blocking device would need to be utilized instead. In such a case, the blocking device would not abut against the roller. This increases the potential for the overhead door to be lifted enough for entrance underneath the overhead door even with the blocking element in place. Also, these prior art systems disclose blocking systems that require extraneous items or tools in order to be mounted.

The overhead door blocking devices that are disclosed in the prior art are not universally functional and therefore cannot be simply interchanged between different models or sizes of overhead door systems and are impractical for use on doors with guide tracks having apertures in disadvantageous positions that prevent the lock from being mounted closely to the roller. The present invention solves these commons problems by retaining its universality even when settling has occurred or with guide tracks having a multitude of aperture positions along the track.

### SUMMARY OF THE INVENTION

In a first embodiment, the present invention provides an overhead door track stop, in combination with an overhead door guide track, having a channel which includes a mounting surface having an aperture therethrough. The channel receives at least one overhead door roller of an overhead door, where the overhead door roller rides in the guide track upon opening and closing of the overhead door. The overhead door track stop, in combination with an overhead door guide track, further includes an elongate rigid body mounted within the channel of the overhead door guide track. The elongate rigid body defines an exterior face and an interior face, a first end having a first end face, and a second end having a second end face. The first end face is positioned in close proximity to a top of an overhead door roller.

The overhead door track stop, in combination with an overhead door guide track, includes at least one slot-shaped aperture that extends along a portion of the elongate rigid body. Also, the present invention provides a track fastener that extends through the slot-shaped aperture and the aperture in the overhead door guide track and thereby secures the elongate rigid body in the overhead door guide track to prevent opening of overhead door due to contact with roller at first end.

In a second embodiment, the present invention provides an overhead door track stop device as in the first embodiment, wherein the slot-shaped aperture ensures that, despite variable placement of the aperture in one overhead door guide track as compared to another overhead door guide track, the first end face is able to be placed in proximity to the overhead door roller in the guide track when the overhead door is closed, as well as allowing the track fastener to extends through the slot-shaped aperture and one of the plurality of apertures.

In a third embodiment, the present invention provides an overhead door guide track stop device as in either the first or second embodiment, wherein the interior face is adjacent to the mounting surface of the overhead door guide track.

In a fourth embodiment, the present invention provides an overhead door guide track stop device as in any of the first through third embodiments, wherein the first end face abuttingly engages with a roller to prevent movement thereof.

In a fifth embodiment, the present invention provides an overhead door guide track stop device as in any of the first through fourth embodiments, comprises a second slot-shaped aperture that is distinct from the first slot-shaped aperture along the elongate rigid body.

In a sixth embodiment, the present invention provides an overhead door guide track stop device as in any of the first through fifth embodiments, wherein the elongate rigid body includes three slot-shaped apertures that are centrally aligned along the elongate rigid body. The three slot-shaped apertures are approximately 1 inch apart, thereby creating two intervening reinforcing bridges.

In a seventh embodiment, the present invention provides an overhead door guide track stop device as in any of the first through sixth embodiments, wherein the length of the elongate rigid body is between 10-18 inches long.

In an eighth embodiment, the present invention provides an overhead door guide track stop device as in any of the first through seventh embodiments, wherein the elongate rigid body is optimally 16 inches long.

In a ninth embodiment, the present invention provides an overhead door guide track stop device as in any of the first through eighth embodiments, wherein the elongate rigid body includes exactly three slot-shaped apertures.

In a tenth embodiment, the present invention provides an overhead door guide track stop device as in any of the first through ninth embodiments, wherein the track fastener is comprised of a bolt and a wingnut.

In a eleventh embodiment, the present invention provides an overhead door guide track stop device as in any of the first through tenth embodiments, wherein the overhead door guide track stop further comprises a hanger member secured to hang the track stop near the overhead door guide track when not in use.

In a twelfth embodiment, the present invention provides an overhead door guide track stop device as in any of the first through eleventh embodiments, wherein the track fastener is a padlock bracket that is designed to receive a padlock.

In a thirteenth embodiment, the present invention provides a method of locking an overhead door in a closed position, the overhead door including a plurality of overhead door rollers riding in a overhead door guide track, the overhead door guide track having a channel including a mounting surface with an aperture therethrough, wherein the method comprises the steps of: positioning the overhead door in a closed position, providing an overhead door track stop and installing the elongate rigid body into the channel of the overhead door guide track. The overhead door track stop includes an elongate rigid body and a slot-shaped aperture. The slot-shaped aperture extends through the elongate rigid body which defines an exterior face and an interior face, a first end having a first end face, and a second end having a second end face. The slot-shaped aperture extends through the elongate rigid body from the interior face to the exterior face. The elongate rigid body is installed into the channel of the overhead door guide track with the first end face in close proximity to a top of an overhead door roller. The step of installing includes: aligning the slot-shaped aperture on the elongate rigid body with at least one aperture in the overhead door guide track channel, and securing the elongate rigid body to the overhead door guide track with a track fastener extending through a slot-shaped aperture and an aperture of the channel.

In a fourteenth embodiment, the present invention provides a method of locking an overhead door as in any of the first through thirteenth embodiments, wherein the method of using the overhead door track stop further includes utilizing a hanger member. Installing the elongate rigid body further includes securing the hanger member to a wall that is adjacent to the overhead door guide track.

### BRIEF DESCRIPTION OF THE DRAWINGS

FIG. 1 is a schematic drawing of an overhead door system showing the environment in which the present invention is employed in accordance with the present invention;

FIG. 2 is a front elevational view of the overhead door guide track taken along the line 2-2 of FIG. 1, including a plurality of apertures in the overhead door guide track channel in accordance with the present invention;

FIG. 3 is a perspective view of the overhead door track stop in accordance with the present invention;

FIG. 4 is a left-side elevational view of the overhead door track stop, shown mounted within an overhead door guide track channel;

FIG. 5 is a front elevational view of the overhead door track stop in accordance with the present invention, shown mounted within the overhead door guide track channel, further displayed with the hanger member selectively secured to a wall;

FIG. 6 is a left-side elevational view of the overhead door track stop in according with the present invention, shown mounted within an overhead door guide track channel with a padlock bracket, designed to receive a padlock that selectively passes through said slot-shaped aperture and an aperture to be secured by a padlock or the like.

### DETAILED DESCRIPTION OF ILLUSTRATIVE EMBODIMENTS

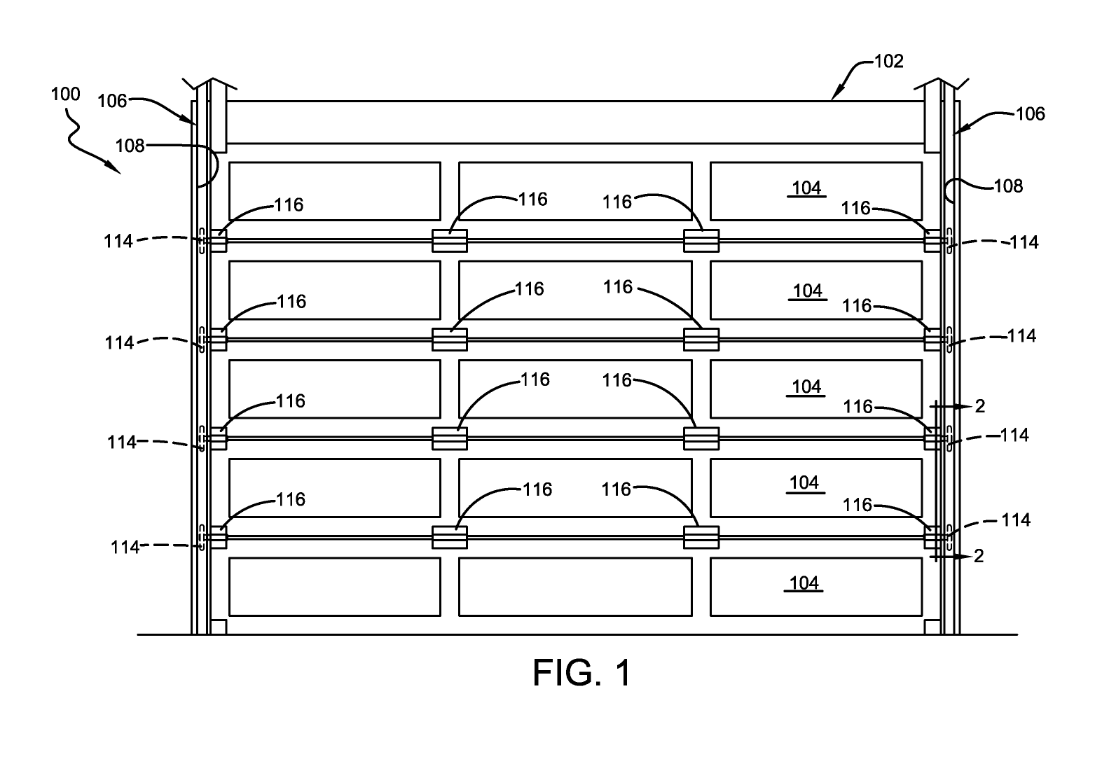

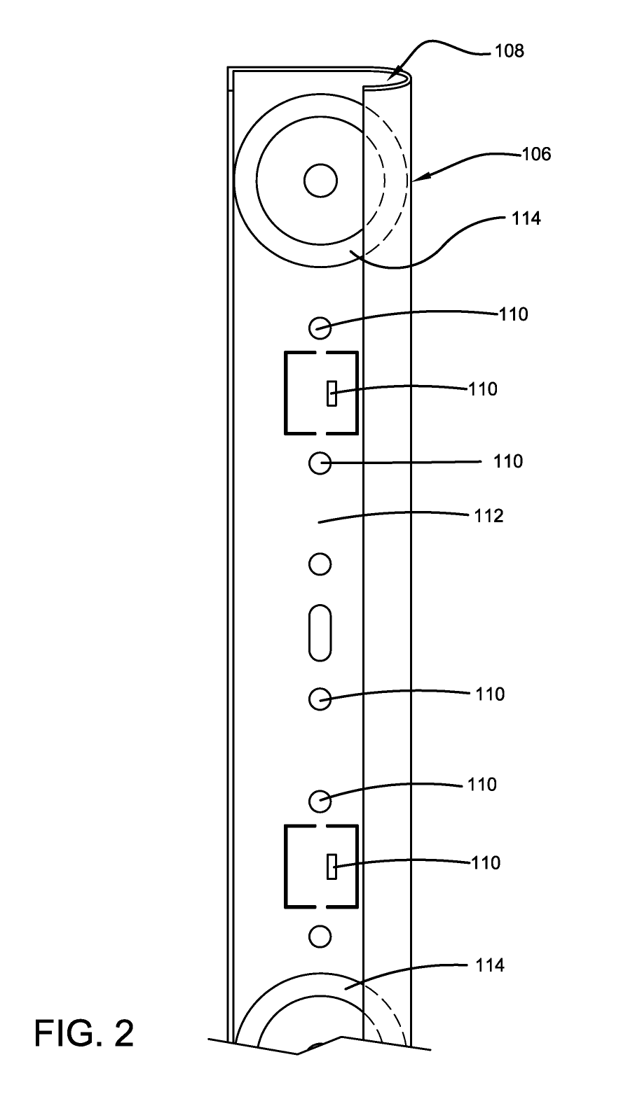

The overhead door track stop of the present invention is employed with common overhead door systems such as that shown in FIGS. 1-2. The overhead door system 100 includes an overhead door 102 having multiple segments 104, wherein the overhead door 102 is received by an overhead door guide track 106. The overhead door guide track 106 includes a channel 108. The channel 108 includes a plurality of apertures 110 on a mounting surface 112. The overhead door 102 includes overhead door rollers 114 and is placed adjacent to hinges 116 which facilitate movement of the overhead door 102 within the channel 108.

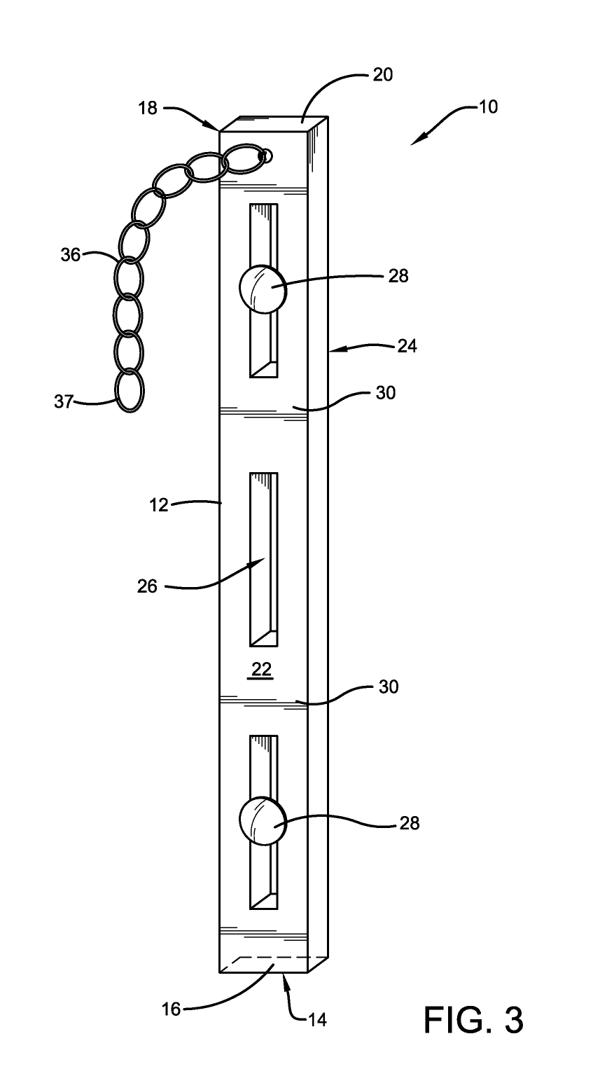

The overhead door track stop of this invention is shown in FIGS. 3-6 and designated by the reference numeral 10. The overhead door track stop 10 is used in combination with an overhead door 102 that rides in an overhead door guide track 106 to open and close. The overhead door guide track 106 has a channel 108 that includes a plurality of apertures 110. In the marketplace, a number of overhead door guide tracks are provided, and the position and shape of these apertures can vary, but a very high percentage of the overhead door guide tracks employed in the industry have apertures of a shape and location suitable for receipt of the overhead door track stop 10 as taught herein. The apertures 110 are located in the mounting surface 112 of the overhead door guide track 106 that generally extends orthogonal to the plane of the closed overhead door 102. The overhead door guide track 106 receives the overhead door rollers 114, and the rollers 114 are positioned proximate the hinges 116 between two neighboring segments 104 of the overhead door 102, such as segments 104 and 104 in FIG. 1. The overhead door rollers 114 guide the opening and closing of the overhead door 102. In many guide tracks, the apertures 110 are positioned on the bottom half of the channel 108, close or in proximity to the first set of overhead door rollers 114.

The overhead door track stop 10 includes an elongate rigid body 12. The elongate rigid body 12 can be formed from different materials, including but not limited to wood, plastic, metal or the like. The material that the elongate rigid body 12 is composed of should be strong enough to withstand attempts to force an overhead door 102 open against the overhead door track stop 10. The elongate rigid body 12 extends from a first end 14, having a first end face 16, to a second end 18, having a second end face 20.

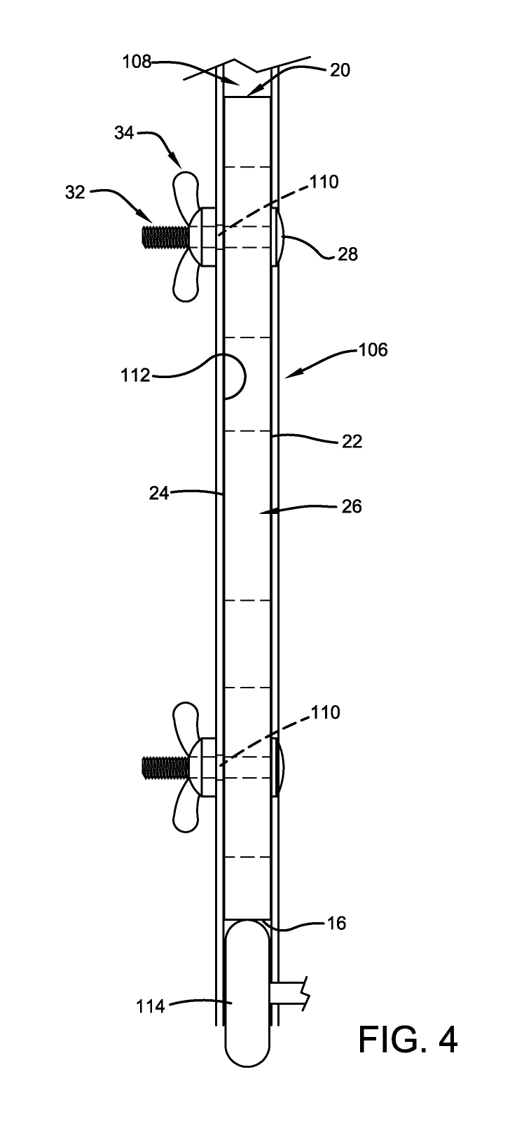

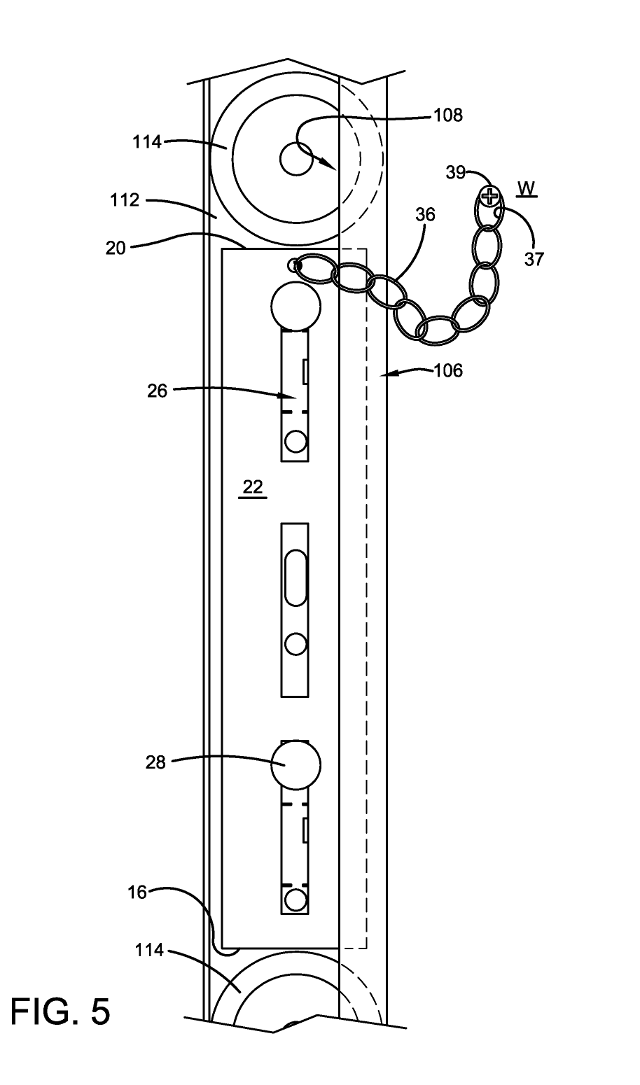

The elongate rigid body 12 includes an exterior face 22 and an interior face 24, and at least one slot-shaped aperture 26 extends through the elongate rigid body 12 from the exterior face 22 to the interior face 24. The slot-shaped aperture 26 extends along a portion of the height of the elongate rigid body 12. In use, the overhead door track stop 10 is positioned in an overhead door guide track 106 with the interior face 24 abutting the mounting surface 112 of the channel 108 and with the first end face 16 of first end 14 abutting or in close proximity to the top of an overhead door roller 114 (FIG. 4). In this position, the slot-shaped aperture 26 aligns with an aperture 110 in the mounting surface 112 and a track fastener 28 is employed to secure the track stop 10 to the overhead door guide track 106 (FIG. 5). This mounting orientation is discuss further below, and is mentioned here to provide the necessary background to understand the importance of the slot-shaped aperture 26.

In particular, employing a slot-shaped aperture 26 allows for variable placement of the elongate rigid body 12 relative to the plurality of apertures 110 through the overhead door guide track 106 to ensure that the first end face 16 can be placed in proximity to an overhead door roller 114 despite the variable placement of the plurality of apertures 110 in the commonly available overhead door guide tracks 106, as described above. It will be appreciated that the variable placement of the apertures 110 results in variable distance between an overhead door roller 114 and one or more apertures 110, and the slot-shape aperture 26 is necessary to permit the first end face 16 to be positioned in close proximity (preferably abutting) the top of an overhead door roller 114 and yet still provide an alignment between the slot-shaped aperture 26 and one or more apertures 110 so that a track fastener 28 can secure the overhead door track stop 10 by extending through those apertures 26, 110. The track fastener 28 simultaneously extends through the slot-shaped aperture 26 and an aperture 110 thereby firmly securing the elongate rigid body 12 to the overhead door guide track 106 to prevent opening of the overhead door 102. Upon attempted opening of the overhead door 102, the overhead door roller 114 immediately engages the first end face 16 of the overhead door track stop 10 and the fixing of the overhead door track stop 10 to the overhead door guide track 106 ensures that the overhead door 102 cannot be opened without significant expenditure of force and resultant structural damage. This will prevent all but the most egregious unauthorized entry at an overhead door.

The slot-shaped aperture 26 is provided to align with an aperture 110 in the overhead door guide track 106 while the first end face 16 of the first end 14 rests in close proximity to the top of an overhead door roller 114. To improve the ability to account for variable placement of the apertures 110 and thus variable distance between them and an overhead door roller 114, in some embodiments, the elongate rigid body 12 includes two or more, and in some embodiments three, slot-shaped apertures 26. Multiple slot-shaped apertures 26 increases the likelihood of being able to align a slot-shaped aperture 26 with one or more apertures 110, while still placing the first end face 16 in close proximity to the top of an overhead door roller 114. Although it is envisioned that one large slot-shaped aperture 26 could extend in height from the top of the top-most slot-shaped aperture 26 to the bottom of the bottom-most slot-shaped aperture 26 in FIG. 3, it is also noted that spacing the slot-shaped apertures 26 from each other creates an intervening reinforcing bridge 30 between neighboring slot-shaped apertures 26. The intervening reinforcing bridge 30 provides further stability and strength to the elongate rigid body 12.

In some embodiments, the elongate rigid body 12 has a height of 10 inches or more to 20 inches or less. In some embodiments, the elongate rigid body 12 has a height of from 10 inches or more to 18 inches or less. In other embodiments, from 12 inches or more to 18 inches or less. In other embodiments, from 14 inches or more to 18 inches or less. In other embodiments, from 15 inches or more to 17 inches or less. In some embodiments, the elongate rigid body 12 is 16 inches. These lengths have been found to ensure that the overhead door track stop 10 can properly mount (as described herein) to one or more of the apertures 110 in most overhead door guide tracks 106 so as to be positioned with the first end face 16 proximate the top of an overhead door roller 114 of an overhead door 102.

In some embodiments, the elongate rigid body 12 has a width from the interior face 24 to the exterior face 22 of from 0.25 inches or more to 1.5 inches or less, which is generally suitable for fitting within most existing overhead door guide tracks 106 without impinging upon undesired structures of the overhead door or guide track itself. In some embodiments, this width is from 0.5 inches or more to 1.25 inches or less. In other embodiments, from 0.5 inches or more to 1 inch or less. In other embodiments from ⅝ inches or more to ⅞ inches or less. In some embodiments, this width is ¾ inches.

In some embodiments, the slot-shaped aperture 26 extends along from 25% or more to 95% or less, of the height of the elongate rigid body 12, wherein the elongate rigid body 12 comprises ≦8 slot-shaped apertures 26. In some embodiments, the slot-shaped aperture 26 extends along from 40% or more to 90% or less, of the height of the elongate rigid body 12, wherein the elongate rigid body 12 comprises ≦6 slot-shaped apertures 26. In some embodiments, the slot-shaped aperture 26 extends along from 50% or more to 85% or less, of the height of the elongate rigid body 12, wherein the elongate rigid body 12 comprises ≦4 slot-shaped apertures 26. In some embodiments, the slot-shaped aperture 26 extends along from 60% or more to 85% or less, of the height of the elongate rigid body 12, wherein the elongate rigid body 12 comprises ≦3 slot-shaped apertures 26. In some embodiments, the slot-shaped aperture 26 extends along from 70% or more to 80% or less, of the height of the elongate rigid body 12, wherein the elongate rigid body 12 comprises ≦2 slot-shaped apertures 26. In some embodiments, the slot-shaped aperture 26 extends along 75%, of the height of the elongate rigid body 12, wherein the elongate rigid body 12 comprises three slot-shaped apertures 26.

In some embodiments, the slot-shaped aperture 26 is approximately 4″ in length and ¼″ in width. In some embodiments, the elongate rigid body 12 includes at least one slot-shaped aperture 26. In some embodiments, the slot-shaped apertures 26 are spaced approximately 1″ apart.

In a specific embodiment, the elongate rigid body 12 is 16 inches in height, ¾ of an inch in width from the interior face 24 to the exterior face 22, and 1.25 inches in length across the interior face 24/exterior face 22. This embodiment includes three slot-shaped apertures 26 of 4 inches in height, the first starting one inch from the first end face 16, the second starting at one inch away from the top of the first (i.e., providing a 1 inch reinforcing bridge 30), and the third starting at one inch away from the top of the second (also thus providing a 1 inch reinforcing bridge), the third ending one inch from the second end face 20. The slot is any suitable width, and in a specific embodiment is ¼ inch in width. This specific embodiment has been found to adequately mount abutting a roller 114 and secured to apertures 110 in the channel, as described above, and note more below.

In some embodiments, the track fastener 28 is a non-tool based fastener, i.e. capable of hand tightening, comprised of a bolt 32 and wingnut 34 (FIG. 4). The track fastener 28 of the present invention allows for the overhead door track stop 10 to be easily fastened within the channel 108 of the overhead door guide track 106 without any extraneous tools or the like. Therefore, the present invention can be conveniently interchanged between overhead door systems and effortlessly transported between properties. The universality of the overhead door track stop 10 allows the devices to be readily transported and used at different properties even though each overhead door system might have different placements of apertures (such as apertures 110) in the channels of their overhead door guide tracks (and different placement of overhead door rollers relative thereto). Additionally, one can purchase a plurality of the overhead door track stops 10 in accordance with this invention and be ensured that they will appropriately mount to a given overhead door system.

In some embodiments, the overhead door track stop 10 includes a hanger member 36 fastened at any appropriate location, but here shown proximate the second end 18 of the elongate rigid body 12 (FIGS. 3 and 5). The hanger member 36 is shown as a chain, but can be any appropriate cordage or other structure for hanging the overhead door track stop 10 as now described. The hanger member 36 provides a wall-fastener structure to secure the overhead door track stop 10 to a either the overhead door 102 or a wall W adjacent the overhead door guide track 106 even while the overhead door track stop 10 is in use. In this way, the overhead door track stop 10 can be removed from being mounted at the overhead door guide track 106 and yet be retained at a useful location for use, when needed. When dismounted from the overhead door guide track 106, the overhead door track stop 10 will simply hang from the hanger member 36. In this embodiment the wall-fastener structure of hanger member 36 is simply a loop 37 that can hang on a hook or screw 39, as shown, but other structures would work just as well and need not be elaborated upon here. This allows for the elongate rigid body 12 to be selectively secured to a wall W and suspended when not in use. The hanger member 36 allows for the elongate rigid body 12 to be quickly accessed to re-install into the overhead door guide track 106 when desired.

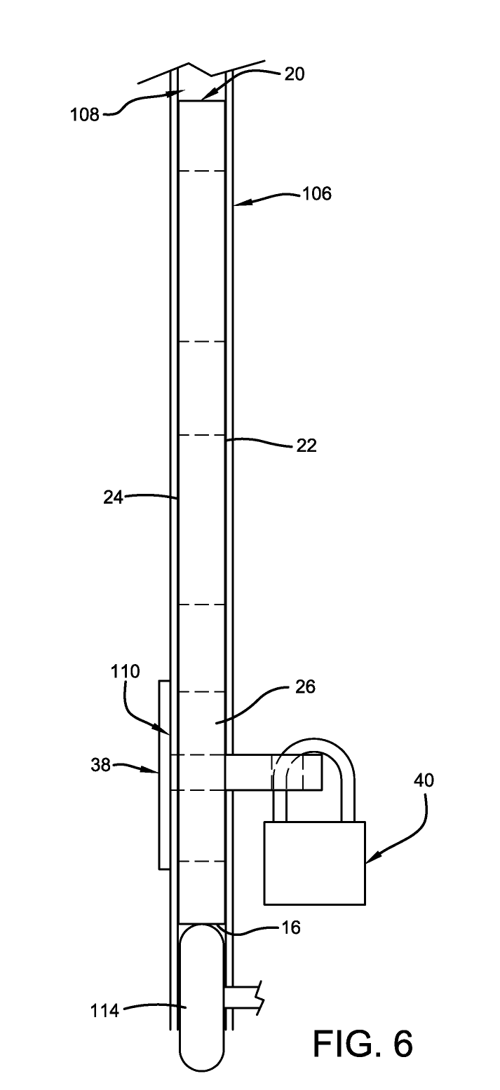

In some embodiments, the overhead door track stop 10 optionally includes a padlock bracket 38 to extend through a slot-shaped aperture 26 and an aperture 110 to secure the elongate rigid body 12 (FIG. 6). The padlock bracket 38 is placed adjacent to the exterior portion of the overhead door guide track 106, and the extended portion first passes through the interior face 24 and then through the exterior face 22 of the elongate rigid body 12. The padlock bracket 38 is designed to receive a padlock 40 or the like to be secured. The padlock bracket 38 may be used in place of the track fastener 28, or in combination with the track fastener 28 to provide additional security from displacement, providing an extra breaking and entering security measure. Someone may wish to more permanently mount the overhead door track stop 10 with a fastener other than manually releasable fasteners, such as a wingnut.

Although likely appreciated from the disclosures above, the overhead door track stop 10 of this invention is employed as follows. First, the overhead door 102 is placed in a closed position. Next, the overhead door track stop 10 is placed within the overhead door guide track channel 108. Next the elongate rigid body 12 is installed into the channel 108 of the overhead door guide track 106 with the first end face 16 in close proximity to (and preferably in contact with) a top of an overhead door roller 114. The installation includes aligning the slot-shaped aperture 26 on the elongate rigid body 12 with at least one aperture 110 in the overhead door guide track channel 108, and securing the elongate rigid body 12 to the overhead door guide track 106 with a track fastener 28 extending through the slot-shaped aperture 26 and the aperture 110 of the overhead door guide track channel 108.

In some embodiments, the method additionally includes selectively attaching a hanger member 36 to either the overhead door 102 or a wall W to serve to suspend the overhead door track stop 10 when not in use.

In some embodiments, the method additionally includes placing a padlock bracket 38 simultaneously through a slot-shaped aperture 26 and an aperture 110 to secure the elongate rigid body 12. The padlock bracket 38 is placed adjacent to the exterior portion of the overhead door guide track 106, and the extended portion first passes through the interior face 24 and then through the exterior face 22 of the elongate rigid body 12. The padlock bracket 38 is secured with a padlock 40 or the like to be secured.

In light of the foregoing, it should be appreciated that the present invention significantly advances the art by providing an overhead door track stop that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. A overhead door track stop in combination with an overhead door guide track having a channel including a mounting surface having an aperture therethrough, the channel receiving at least one overhead door roller of an overhead door, the overhead door roller riding in the guide track upon opening and closing of the overhead door, the combination comprising:
an elongate rigid body mounted within the channel of the overhead door guide track, wherein said elongate rigid body defines an exterior face and an interior face, a first end having a first end face, and a second end having a second end face, said first end face being positioned in close proximity to a top of an overhead door roller;
at least one slot-shaped aperture extending along a portion said elongate rigid body; and
a track fastener extending through said slot-shaped aperture and the aperture in the overhead door guide track thereby securing the elongate rigid body in the overhead door guide track and preventing the opening of overhead door due to contact of said overhead door roller with said first end of said elongate rigid body.

2. The overhead door track stop combination of claim 1, wherein said slot-shaped aperture ensures that, despite variable placement of the aperture in one overhead door guide track as compared to another overhead door guide track, said first end face can be placed in proximity to the overhead door roller in the guide track when the overhead door is closed and yet said track fastener can extend through aid slot-shaped aperture and one of the plurality of apertures to achieve the claimed combination.

3. The overhead door track stop combination of claim 1, wherein said interior face is adjacent to said mounting surface of said overhead door guide track.

4. The overhead door track stop combination of claim 2, wherein said first end face abuttingly engages with a roller to prevent movement thereof.

5. The overhead door track stop combination of claim 4, comprises a second slot-shaped aperture distinct from said first slot-shaped aperture along the elongate rigid body.

6. The overhead door track stop combination of claim 5, wherein said elongate rigid body includes three slot-shaped apertures centrally aligned along said elongate rigid body, approximately 1 inch apart, thereby creating two intervening reinforcing bridges.

7. The overhead door track stop combination of claim 6, wherein the length of said elongate rigid body is between 10-18 inches long.

8. The overhead door track stop combination of claim 6, wherein said elongate rigid body is optimally 16 inches long.

9. The overhead door track stop combination of claim 8, wherein said elongate rigid body includes exactly three slot-shaped apertures.

10. The overhead door track stop combination of claim 9, wherein said track fastener is comprised of a bolt and a wingnut.

11. The overhead door track stop combination of claim 10, further comprising a hanger member secured to hang the track stop near the overhead door guide track when not in use.

12. The overhead door track stop combination of claim 9, wherein said track fastener is a padlock bracket designed to receive a padlock.

13. A method of locking an overhead door in a closed position, the overhead door including a plurality of overhead door rollers riding in a overhead door guide track, the overhead door guide track having a channel including a mounting surface with an aperture therethrough, the method comprising the steps of:
positioning the overhead door in a closed position,
providing a overhead door track stop having:
an elongate rigid body, said elongate rigid body defining an exterior face and an interior face, a first end having a first end face, and a second end having a second end face, and
a slot-shaped aperture extending through said elongate rigid body from said interior face to said exterior face;
installing said elongate rigid body into the channel of the overhead door guide track with said first end face in close proximity to a top of an overhead door roller, said step of installing including:
aligning said slot-shaped aperture on said elongate rigid body with at least one aperture in the overhead door guide track channel, and
securing said elongate rigid body to the overhead door guide track with a track fastener extending through said slot-shaped aperture and said aperture of said channel, such that opening of overhead door is prevented due to contact of said overhead door roller with said first end of said elongate rigid body.

14. The method of claim 13, wherein the overhead door track stop further includes a hanger member, and said step of installing further includes securing the hanger member to a wall adjacent the overhead door guide track.
